(19) United States
(12) Patent Application Publication
(10) Pub. No.: US 2022/0166282 A1
(43) Pub. Date: May 26, 2022

(54) ELECTRIC MOTOR WITH BAYONET LOCK BETWEEN END SHIELD AND BUSBAR UNIT

(71) Applicant: NIDEC Motors & Actuators (Germany) GmbH, Bietigheim-Bissingen (DE)

(72) Inventors: Jürgen SCHMID, Brackenheim (DE); Thomas KÜBLER, Untergruppenbach (DE)

(21) Appl. No.: 17/534,692

(22) Filed: Nov. 24, 2021

(30) Foreign Application Priority Data
Nov. 26, 2020 (DE) 102020131413.2

(51) Int. Cl. H02K 5/15; H02K 3/50; H02K 5/22; F16D 1/112

(52) U.S. Cl. CPC H02K 5/15; H02K 3/50; H02K 2203/09; F16D 1/112; H02K 5/225

(57) ABSTRACT

An electric motor includes a rotor which is rotatably supported about an axis of rotation in a bearing which is accommodated in an end shield, and a stator which externally surrounds the rotor and includes wound coils. The wound coils include at least one winding wire including winding wire end portions electrically contacted at ends with bus bars of a bus bar assembly, the busbar assembly being arranged on a top side of the stator and the end shield being seated on a top side of the busbar assembly, the end shield and the busbar assembly being directly connected to one another by a bayonet lock.

### CROSS REFERENCE TO RELATED APPLICATION

The present application claims priority under 35 U.S.C. § 119 to German Application No. 10 2020 131 413.2, filed on Nov. 26, 2020, the entire contents of which are hereby incorporated herein by reference.

### 1. FIELD OF THE INVENTION

The present disclosure relates to an electric motor.

### 2. BACKGROUND

Electric motors referred to as internal rotor motors, have a rotor that includes a motor shaft and is rotatably mounted in a housing. The rotor is provided with permanent magnets. A stator is arranged around the rotor, which carries a number of windings on an iron core. When suitably controlled, the windings produce a magnetic field which drives the rotor to rotate. The windings are usually of three-phase design and are accordingly provided with three electrical connections via which the windings can be connected to a controller (ECU). The ends of the windings are contacted via busbars. Two bearing systems are usually provided to fix the rotor. Often these bearings are designed as ball bearings, with the electromagnetic assemblies located between the bearings. For motors with increased noise requirements, the bearings are preloaded with a spring element. As a result, the end shields accommodating the bearings are subjected to an axial force. For this reason, both end shields must be connected to the motor housing in such a way that the interfaces can absorb the axial forces that occur. In the case of a deep-drawn motor housing, the end shield is often attached to the motor housing by means of an interference fit due to the specified boundary conditions. This can lead to deformations of the motor housing or such a connection limits the pull-out forces of the components pressed into each other.

### SUMMARY

Example embodiments of the present disclosure provide electric motors each of which includes a simple connection of an end shield to a motor housing to absorb axial forces.

For the purpose of the geometrical description of an electric motor, an axis of rotation of the motor is assumed to be a central axis and an axis of symmetry. A stator according to an example embodiment of the present disclosure is arranged concentrically with the axis of rotation and a rotor. The axis of rotation simultaneously defines an axial direction in which a thickness of a stator pack and an axial length of the motor are specified. Moreover, with respect to the central axis, a radial direction corresponds to a direction away from the central axis, and a circumferential direction corresponds to a direction tangential to a certain radius arranged in the radial direction. The connection side of the stator, where the winding wires are connected to the busbar arrangement, is described as a top side of the stator.

An electric motor according to an example embodiment of the present disclosure includes a rotor which is mounted rotatably about an axis of rotation in a bearing which is accommodated in an end shield, and a stator which surrounds the rotor externally and includes wound coils including at least one winding wire with winding wire end sections, the winding wire end sections being electrically contacted at an end surface with busbars of a busbar assembly, the busbar assembly being on a top side of the stator and the end shield being seated on a top side of the busbar assembly.

The end shield and the busbar assembly are directly connected to each other by a bayonet lock. No high forces occur when the two components are connected. In addition, it is advantageous that no additional components are required, as the connection is made directly.

Preferably, the bearing plate includes projections on an underside which can be inserted into corresponding recesses on the upper side of the busbar assembly to define the bayonet lock. The connection is thus made directly between the components. The projections and corresponding recesses are preferably evenly spaced in the circumferential direction. The projections and corresponding recesses are preferably arranged on an outer circumference of the respective component such that a particularly secure and firm connection can be provided.

In an example embodiment of the present disclosure, the projections include hooks each engaging an undercut of a recess to define a connection of the end shield to the busbar assembly in the axial direction.

It is also advantageous if the bayonet lock is secured by a catch in the end shield.

Preferably, the end shield includes an interspersing recess with is penetrated by a connector including power source connection terminals electrically connected to the bus bars, the connector providing a connection to a controller to control the electric motor. The bearing is preferably biased by a spring.

The electric motor preferably includes a motor housing, which is preferably produced by deep drawing, which surrounds the stator circumferentially and which includes a seat for the end shield. In addition, a flange to connect to a gearbox may be integrally defined on the motor housing, the flange preferably including screw-on lugs.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 is a perspective view of an electric motor according to an example embodiment of the present disclosure as seen from above.

FIG. 2 is a three-dimensional view of a stator with busbar assembly and end shield according to an example embodiment of the present disclosure.

FIG. 3 is a detailed view of a connection of the busbar assembly and the end shield.

FIG. 4 is a side view of the connection between the busbar assembly and the end shield.

### DETAILED DESCRIPTION

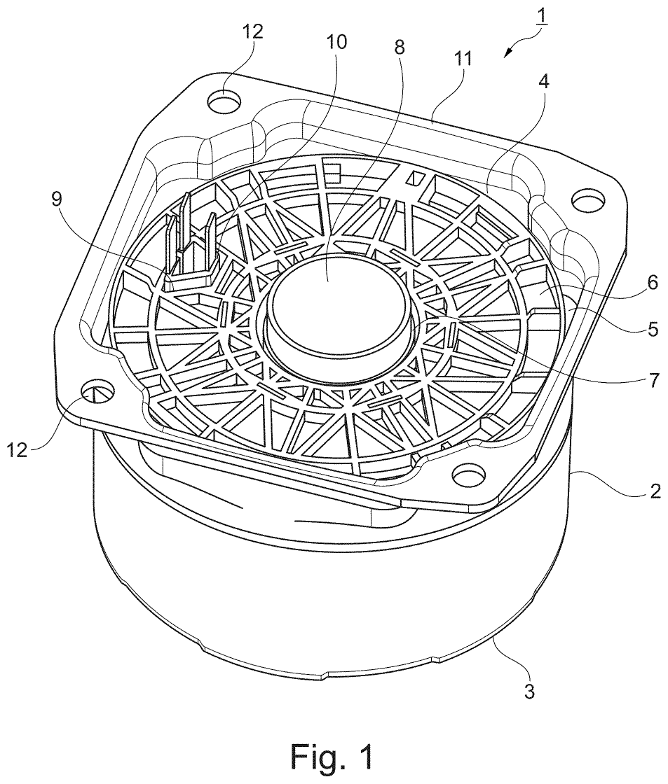

FIG. 1 shows an electric motor 1 with a deep-drawn motor housing 2. The motor housing 2 is substantially cylindrical and has a bottom 3 and an opening 4 opposite the bottom 3. FIG. 1 shows a view of the opening 4. An end shield 6 is arranged in the region of the opening 4. The end shield 6 has a central opening 7 under which a bearing, not shown, is located for supporting the rotor shaft 8. In the assembled state, the rotor shaft 8 passes through the bearing and the end shield 6. In particular, the bearing is designed as a ball bearing and is spring-preloaded. The end shield 6 lies entirely within the motor housing 2 and is fully surrounded by the latter. The end shield 6 has an opening 9 which passes through in the edge region and through which a plug connector 10 projects. The plug connector 10 forms an electrical contact to a busbar assembly not shown, which in turn contacts the winding wire ends of the stator. The connector 10 is connected to a controller, not shown, for controlling the electric motor 1.

The motor housing 2 is formed above the end shield 6, in the end region as a flange 11 with screw-on lugs 12, by means of which the electric motor 1 can be connected to a gear unit or hydraulic pump, for example. The motor housing 2 is formed, for example, as a deep-drawn part made of steel, whereas the end shield 6 is preferably made of plastic.

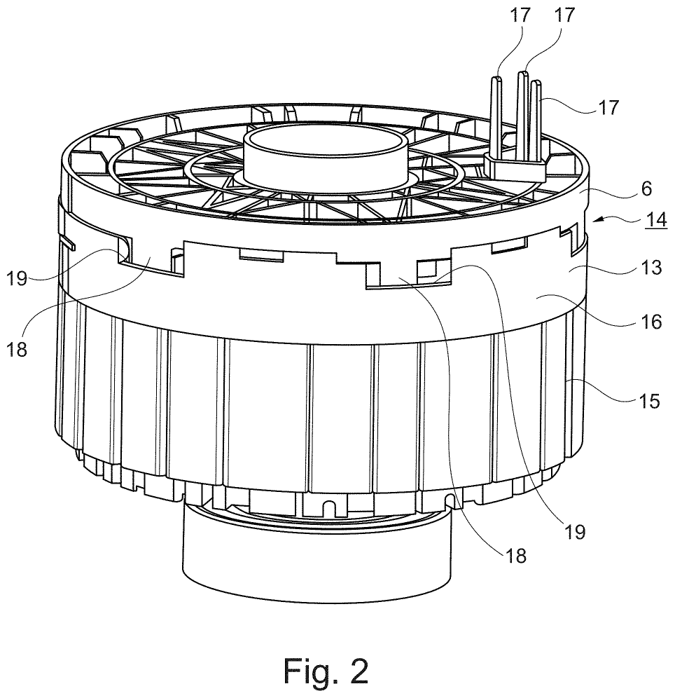

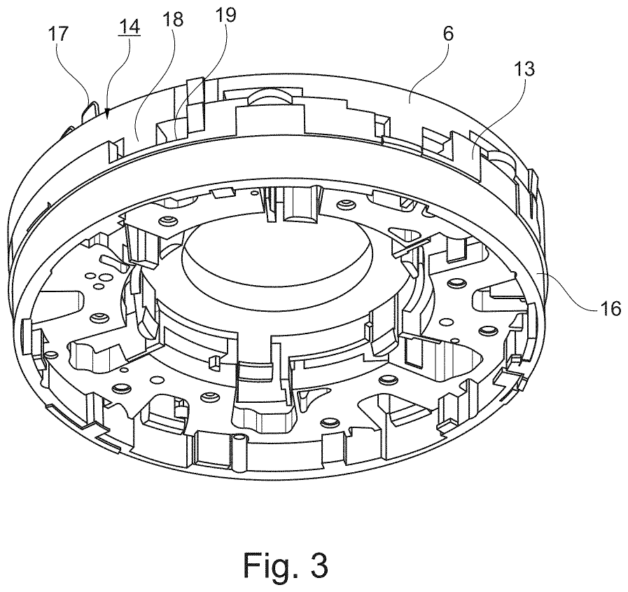

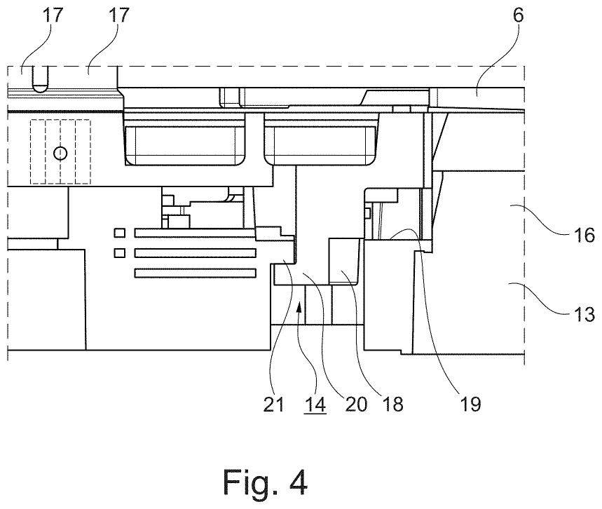

As shown in FIGS. 2 to 4, the end shield 6 is directly connected to a busbar assembly 13 by means of a bayonet catch 14.

The busbar assembly 13 is located above the stator 15 of the electric motor. The stator 15 is fixed in the motor housing 2. The busbar assembly 13 conventionally comprises an overmolded busbar holder 16 and busbars not shown arranged in the busbar holder 16. The busbars are made of an electrically conductive material, preferably metal, in particular copper. The busbar holder 16 is at least partly or entirely made of an electrically insulating material, so that short circuits between the busbars can be effectively prevented. Preferably, the busbar holder 16 is manufactured by injection molding. The bus bar holder 16 is in contact with and connected to the stator 15 on an axial side thereof (upper side). The winding wire ends, not shown, of the windings arranged in the stator 15 are electrically connected to the busbars in a known manner. The bus bar assembly 13 is arranged to electrically contact the coils of the stator by means of the bus bars. Each of the busbars has a power source connection terminal element 17, which is adapted to be electrically connected to a power source. The coils are grouped into three phase groups. A total of three power source connection terminal elements 17 are therefore provided, which, as shown in FIGS. 1 and 2, project from the top of the bearing plate and form part of the connector 10.

The bayonet catch 14 is formed by projections 18, evenly spaced in the circumferential direction, on the side of the end shield 6 close to the busbar holder and corresponding recesses 19 on the upper side of the busbar holder 16. In the example embodiment shown, a total of 6 projections 18 are arranged at a respective distance of 60° about the axis of rotation. The projections 18 are hook-like, in particular L-shaped. They are preferably formed on the outer circumference of the end shield on a lower side. In other words, they are located at an outer end of the end shield. Preferably, they are formed flush with the edge of the end shield. The projections 18 are inserted into the recesses 19 of the bus bar holder 16 in the axial direction and then rotated through a certain angle in the circumferential direction with respect to the axial direction, so that the hooks 20 engage in undercuts 21 of the recesses 19 and form a fixed connection of the two components 6,16 which can be loaded in the axial direction. The components 6,16 can be separated from each other again by rotation in the opposite direction.

On the underside of the end shield, a latching lug is preferably formed which, as soon as the bayonet catch forms an axial connection with the end shield by rotating the busbar assembly, engages or latches in the busbar holder from above and serves as a safeguard against loosening of the bayonet catch. The latching lug is spring-loaded. When the components to be connected are turned against each other, the latching lug 1 is initially pretensioned in the axial direction. As soon as a corresponding recess on the upper side of the busbar overmolding (busbar holder) is reached during rotation, the latching lug engages in this recess in the axial direction downwards and forms a safeguard against opening of the bayonet catch.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric motor, comprising:
a rotor which is mounted rotatably about an axis of rotation in a bearing which is supported on an end shield;
a stator which surrounds the rotor on an outside and includes wound coils including at least one winding wire including winding wire end sections; and
a busbar assembly on a top side of the stator, the winding wire end sections being electrically contacted at an end with busbars of the busbar assembly; wherein
the end shield is seated on a top side of the busbar assembly; and
the end shield and the busbar assembly are directly connected to one another by a bayonet lock.

2. The electric motor according to claim 1, wherein the end shield includes projections on an underside which can be inserted into corresponding recesses on the top side of the busbar assembly to define a bayonet catch.

3. The electric motor according to claim 2, wherein the projections include hooks each engaging an undercut of a respective one of the recess to define a connection of the end shield to the busbar assembly in the axial direction.

4. The electric motor according to claim 2, wherein the bayonet catch is secured via a latching lug of the end shield.

5. The electric motor according to claim 1, wherein the end shield includes an interspersing recess penetrated by a connector including power source connection terminals electrically connected to the bus bars, the connector defining a connection to a controller to drive the electric motor.

6. The electric motor according to claim 1, wherein the electric motor includes a motor housing, which surrounds the stator circumferentially and which includes a seat for the end shield.
